(19) United States
(12) Patent Application Publication
(10) Pub. No.: US 2026/0308873 A1
(43) Pub. Date: Oct. 8, 2026

(54) SCREENING BUCKET

(71) Applicant: SIMEX ENGINEERING S.R.L., San Giovanni in Persiceto (Bologna) (IT)

(72) Inventor: Mirco RISI, San Giovanni in Persiceto (Bologna) (IT)

(21) Appl. No.: 19/635,613

(22) Filed: Mar. 31, 2026

(30) Foreign Application Priority Data
Apr. 7, 2025 (IT) 102025000007434

(51) Int. Cl. E02F 7/06; B02C 4/02; E02F 3/407

(52) U.S. Cl. CPC E02F 7/06; B02C 4/02; E02F 3/407

(57) ABSTRACT

A screening bucket has two opposite side walls defining an unloading opening, a screening assembly having a screening shaft extending between two opposite shaft ends and rotatable about a rotation axis and a plurality of screening tools connected to the screening shaft. A transmission system, positioned at at least one of the two opposite side walls and configured to transfer mechanical and/or hydraulic power to the screening assembly, has a rotor positioned at one of the side walls, protruding into the loading compartment and facing one of the two opposite shaft ends. The screening shaft forms a shaft coupling portion forming a shaft recess. The rotor has a rotor end, the rotor end and the shaft recess being shaped to allow a torque transmission from the rotor to the screening shaft. A clamp is removably clamped to the shaft coupling portion to constrain the rotor end in the shaft recess.

### CROSS-REFERENCE TO RELATED APPLICATION

This application claims priority to Italian Patent Application No. 102025000007434 filed Apr. 7, 2025, the contents of which are incorporated by reference in their entirety.

### FIELD OF THE INVENTION

The present invention relates to a screening bucket adapted to be applied on machines for handling detrital material, e.g. excavating machines or loading machines, for collecting, crushing and screening the detrital material. Hereinafter, screening bucket will also mean crusher bucket.

### BACKGROUND OF THE INVENTION

Screening buckets, equipped with a box-shaped bucket body and at least one screening assembly arranged inside the bucket body and configured to screen detrital material, are known.

The screening assembly generally comprises a screening shaft on which a plurality of screening plates are installed. The shaft is pivotally connected to two opposite side walls of the bucket body.

In the prior art, the screening shaft is rotatably connected to the bucket body, e.g., by means of bearings. Furthermore, one or both ends of the screening shaft are inserted through the side walls of the bucket body to connect them to appropriate power transmission means.

Indeed, the power transmission means are generally positioned externally to the bucket body to prevent them from being damaged or fouled by coming into contact with the material to be screened. The power transmission means may comprise gears or pinions or pulleys mounted at the end of the screening shaft, and connected to a dedicated drive, e.g., by means of chains or belts.

Considering the harsh conditions in which they operate, the screening assemblies require frequent maintenance to replace damaged or worn parts. To perform maintenance, it is necessary to disassemble the screening assemblies from the bucket body. In the prior art, this operation requires disassembling the gears assembled on the screening shaft, then the bearings which support the screening shaft and finally pulling out the screening shaft from one of the two side walls of the bucket body, inserting it more into the opposite side wall, until extracting it from the first side wall, then tilting it and pulling it out also from the second.

Therefore, it is a laborious, slow, and cumbersome operation, which, furthermore, must be repeated in reverse to reassemble the screening assembly to the bucket body.

Similarly, such operations are also required to perform the size change of the screening plates to modify the screening size.

EP4428307A1 describes a screening bucket comprising a rotor, operatively connected to power transmission means, protruding from a side wall of the bucket body, and at least one screening shaft. The screening shaft is fastened to the transmission means by positioning an end of the shaft axially abutting against the rotor, preserving the axial alignment and at the same time fastening the end of the shaft to the rotor by means of a pair of half-clamps fitted on both the rotor and the end of the shaft, and screwed and tightened against each other so as to fasten the shaft to the rotor.

Such known solution has an undesirably large axial dimension. Furthermore, such known configuration requires an undesirable stressing of the fastening means, because the torque transmitted from the rotor to the shaft end is necessarily also transferred to the half-clamps, as well as to the screws which fasten and tighten the half-clamps to one another, which have a reduced torsional and shear strength with respect to the shaft and the rotor.

DE102022126952B3 describes a screening bucket comprising a rotor, operatively connected to power transmission means, protruding from a side wall of the bucket body, and at least one screening shaft. Both the rotor and the screening shaft have respective radial through holes. The fastening of the screening shaft to the transmission means involves positioning one end of the shaft radially abutting against the rotor to radially align the respective through holes, and fastening the shaft to the rotor by inserting and screwing one or more screws into the through holes.

This known solution weakens the rotor because it is perforated, and furthermore displays undesired axial dimensions due to the presence of an axial clamp.

EP2666542B1 describes a screening bucket comprising a rotor, operatively connected to power transmission means, protruding from a side wall of the bucket body, and at least one screening shaft. Both the rotor and the end of the screening shaft have shaped portions for an axial geometric coupling. The fastening of the screening shaft to the transmission means involves achieving the geometric coupling between the rotor and the shaft end and then inserting an axial screw through both the rotor and the shaft end, so as to screw and fasten the rotor to the shaft.

This known solution requires undesirably long assembly and disassembly times, because the axial screw is positioned at the transmission means and is inserted into the screening assembly from an external side of the side wall of the bucket body, opposite to the screening assembly.

Therefore, a need is felt for an improved screening bucket which reduces the complexity and time needed to assemble and disassemble the screening assemblies to and from the bucket body, and which has reduced stress of the connection means of the screening assemblies to the bucket body.

### SUMMARY OF THE INVENTION

The object of the present invention is to provide an improved screening bucket, which overcomes at least some of the drawbacks identified in the prior art.

It is a particular object of the present invention to provide a screening bucket which reduces the complexity and time needed for assembling and dissembling the screening assemblies to the bucket body, and which has reduced stress of the connection means of the screening assemblies to the bucket body.

These and other objects are achieved by means of a screening bucket according to the independent claim.

The dependent claims relate to preferred and advantageous embodiments of the present invention.

### FIGURES

In order to better understand the invention and appreciate the advantages thereof, some non-limiting exemplary embodiments thereof will be described below with reference to the accompanying drawings, in which:

FIG. 1 is a perspective view of a screening bucket, according to an embodiment of the present invention;

FIG. 2 is a further perspective view of the screening bucket shown in FIG. 1, in partially disassembled configuration;

FIG. 3 is a perspective view of the screening bucket shown in FIG. 2, free of screening tools;

FIG. 4 is a perspective view of the screening bucket shown in FIG. 3, free of screening shafts;

FIG. 5 is a detailed view of the screening bucket shown in FIG. 4;

FIG. 6 is a further detailed view of the screening bucket shown in FIG. 4, showing visible and non-visible details;

FIG. 7 is a front perspective detailed view of a screening bucket, in a partially exploded configuration, according to an embodiment of the present invention;

FIG. 8 is a rear perspective view of the detailed view shown in FIG. 7;

FIG. 9 is an axial section view of a screening bucket assembly, according to an embodiment of the present invention;

FIG. 10 is an axial section view in exploded configuration of the assembly shown in FIG. 9;

FIG. 11 is a partial side view of a screening assembly, showing a shaft end coupled to a rotor;

FIG. 12 is a transverse section view of a detail of a screening assembly of the screening bucket shown in FIG. 1, showing an axial containment system; and

FIG. 13 is a transverse cross-section view in exploded configuration of the detail shown in FIG. 12.

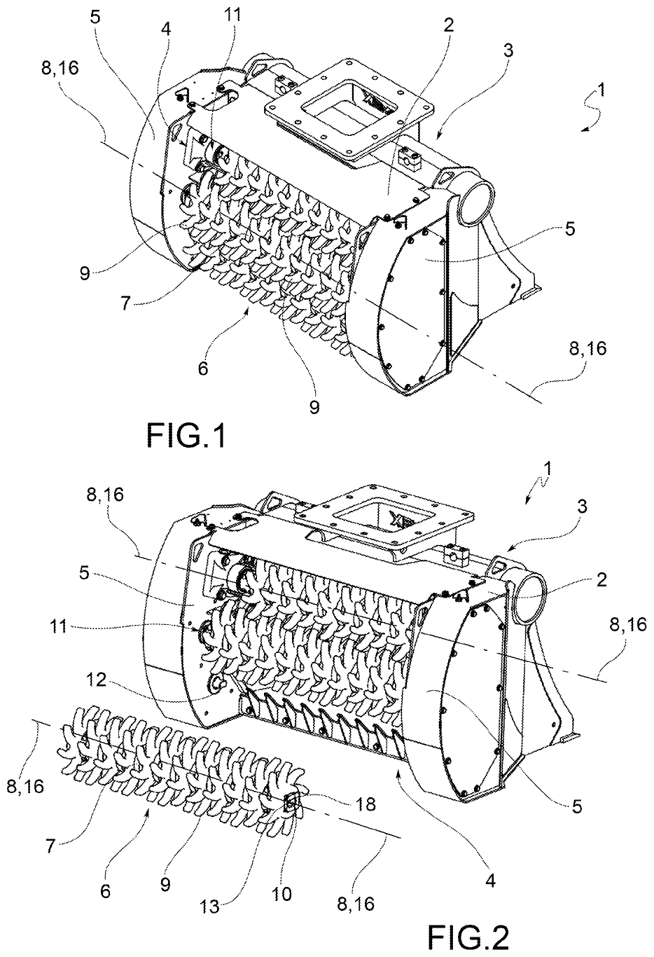

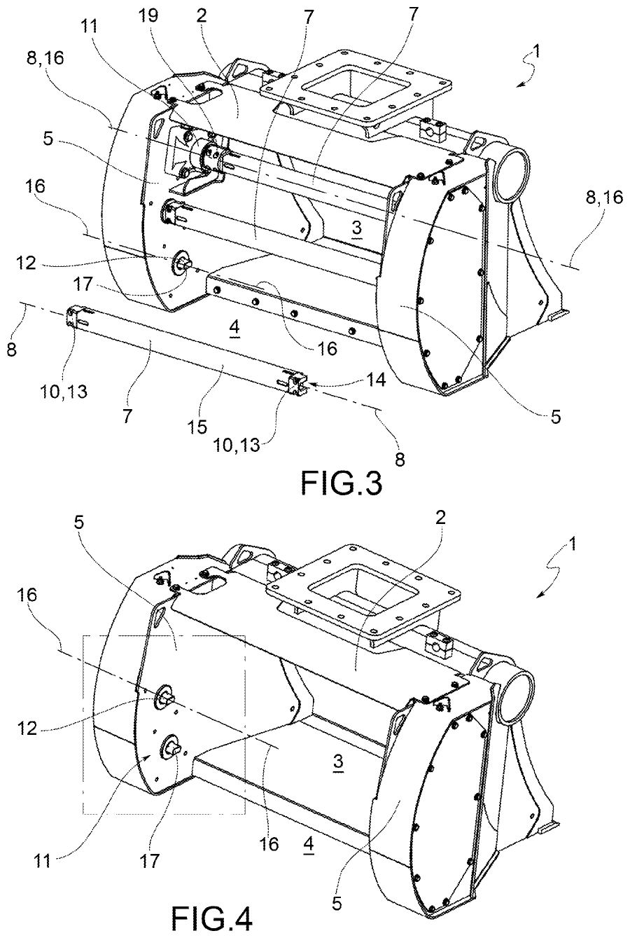

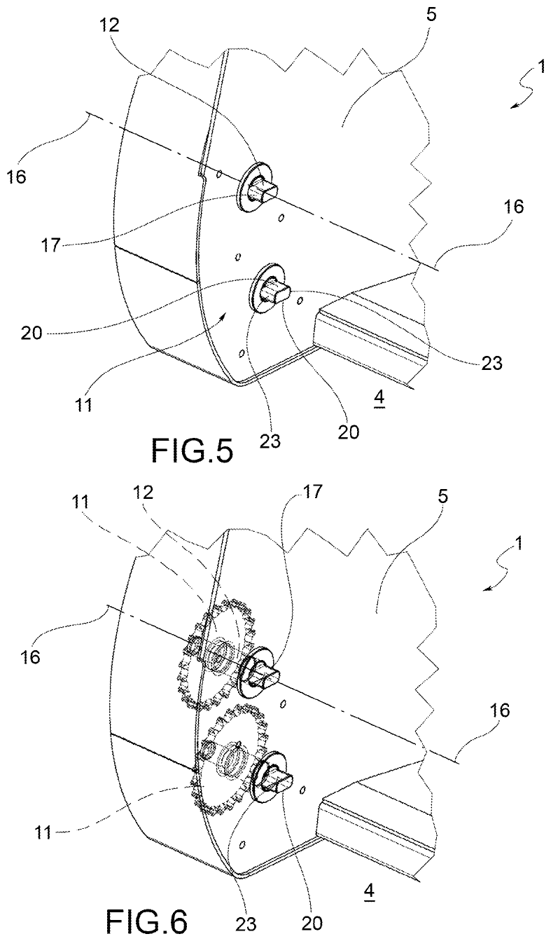

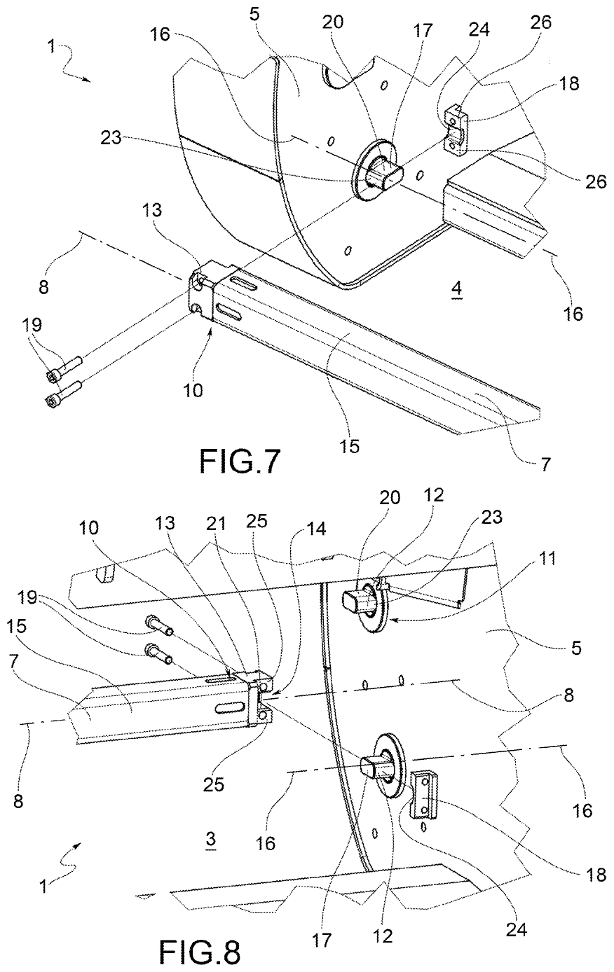

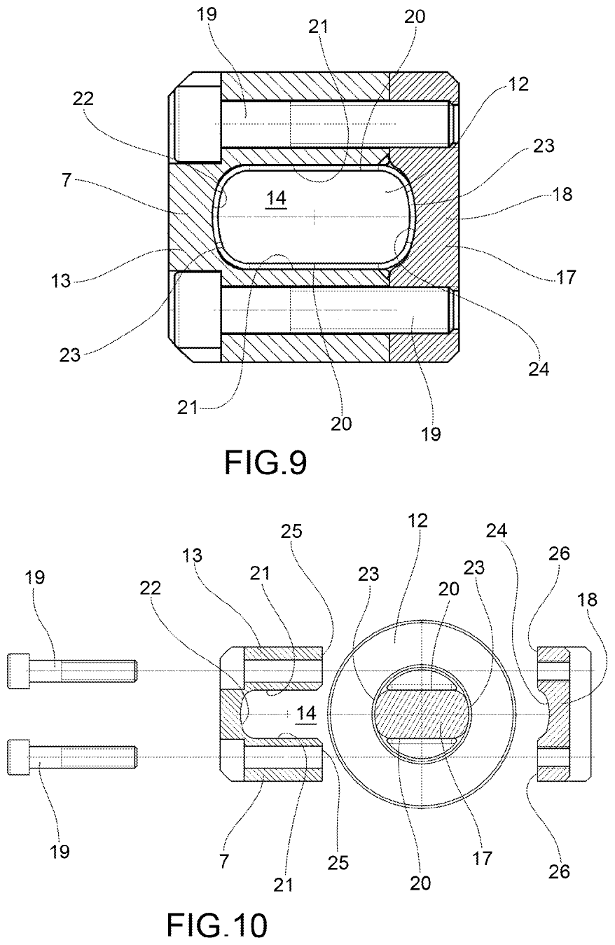

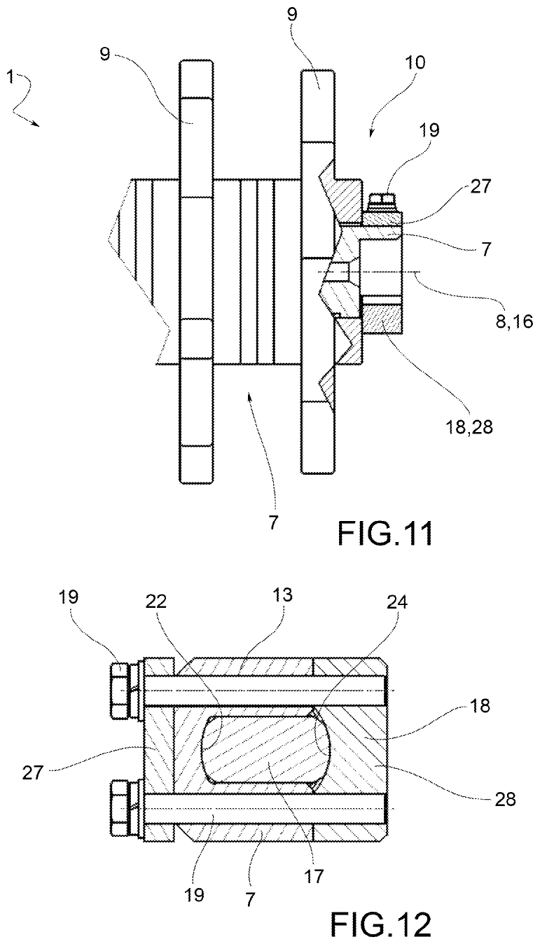

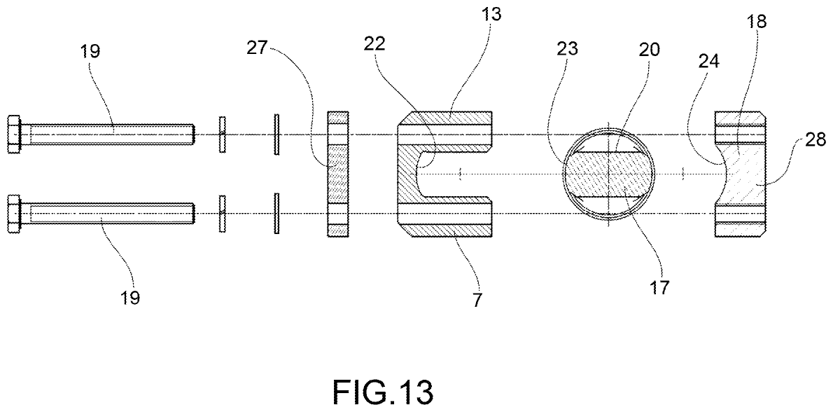

### DETAILED DESCRIPTION

With reference to the figures, a screening bucket is generally indicated by reference numeral 1.

The screening bucket 1 comprises a bucket body 2, optionally box-shaped.

The bucket body 2 defines a loading compartment 3 and an unloading opening 4. Furthermore, the bucket body 2 comprises two opposite side walls 5 which at least partially define the unloading opening 4.

The screening bucket 1 comprises at least one screening assembly 6, in particular, configured to screen detrital material.

The screening assembly 6 comprises a screening shaft 7, extending between two opposite shaft ends 10. Furthermore, the screening shaft 7 is rotatable about a rotation axis 8, optionally substantially transverse to the side walls 5.

Furthermore, the screening assembly 6 comprises a plurality of screening tools 9 connected to the screening shaft 7. In particular, the screening tools 9 extend substantially along respective planes transverse to the rotation axis 8. Specifically, the screening assembly 6 is positioned at the unloading opening 4.

The screening bucket 1 comprises a transmission system 11, positioned at at least one of the side walls 5. The transmission system 11 is configured to transfer mechanical and/or hydraulic power to the screening assembly 6.

The transmission system 11 comprises a rotor 12 positioned at a side wall 5. Furthermore, the rotor 12 extends protruding into the loading compartment 3 and facing one of the shaft ends 10, preferably facing coaxial to one of the shaft ends 10.

The rotor 12 defines a rotor axis 16. Preferably, in a configuration connected to the screening shaft 7, the rotor axis 16 is positioned substantially coincident with the rotation axis 8.

Either the screening shaft 7 or the rotor 12 forms a recess 14 open at least in a direction transverse to an axis parallel to the rotation axis 8 or radial to the rotation axis 8.

The recess 14 is blind in a direction transverse to an axis parallel to the rotation axis 8 or radial to the rotation axis 8.

The other between the screening shaft 7 or the rotor 12 comprises an end 17 removably inserted in the recess 14, so as to achieve a geometric coupling between the screening shaft 7 and the rotor 12.

The end 17 and the recess 14 are shaped so as to allow torque transmission from the rotor 12 to the screening shaft 7.

Furthermore, the screening bucket 1 comprises a clamp 18 removably connected to the screening shaft 7 or the rotor 12 so as to constrain the end 17 into the recess 14.

Advantageously, a screening bucket 1 thus configured allows quick and easy assembly and disassembly of the screening assemblies 6 from and to the bucket body 2, and has reduced stress on the connection means, which allow the assembly and disassembly, and which further allow the correct centering between the screening shaft 7 and the rotor 12.

According to a further aspect of the present invention, the screening bucket 1 comprises a bucket body 2, optionally box-shaped.

The bucket body 2 defines a loading compartment 3 and an unloading opening 4. Furthermore, the bucket body 2 comprises two opposite side walls 5 which at least partially define the unloading opening 4.

The screening bucket 1 comprises at least one screening assembly 6, in particular, configured to screen detrital material.

The screening assembly 6 comprises a screening shaft 7, extending between two opposite shaft ends 10. Furthermore, the screening shaft 7 is rotatable about a rotation axis 8, optionally substantially transverse to the side walls 5.

Furthermore, the screening assembly 6 comprises a plurality of screening tools 9 connected to the screening shaft 7. In particular, the screening tools 9 extend substantially along respective planes transverse to the rotation axis 8. Specifically, the screening assembly 6 is positioned at the unloading opening 4.

The screening bucket 1 comprises a transmission system 11, positioned at at least one of the side walls 5. The transmission system 11 is configured to transfer mechanical and/or hydraulic power to the screening assembly 6.

The transmission system 11 comprises a rotor 12 positioned at a side wall 5. Furthermore, the rotor 12 extends protruding into the loading compartment 3 and facing one of the shaft ends 10, preferably facing coaxial to one of the shaft ends 10.

The rotor 12 defines a rotor axis 16. Preferably, in a configuration connected to the screening shaft 7, the rotor axis 16 is positioned substantially coincident with the rotation axis 8.

The screening shaft 7 forms a shaft coupling portion 13 at the shaft end 10 facing the rotor 12.

The shaft coupling portion 13 forms a shaft recess 14, open at least in a direction transverse to an axis parallel to the rotation axis 8 or radial to the rotation axis 8.

The shaft recess 14 is blind in a direction transverse or radial to the rotation axis 8. In other words, the shaft recess 14 does not extend through the shaft coupling portion 13, in a direction transverse or radial to the rotation axis 8.

Preferably, the shaft recess 14 is also open in a direction coaxial with the rotation axis 8, towards the rotor 12.

The rotor 12 comprises a rotor end 17 facing the shaft end 10. The rotor end 7 is removably inserted in the shaft recess 14 so as to achieve a geometric coupling with the shaft coupling portion 13, specifically with the shaft recess 14.

The rotor end 17 and the shaft recess 14 are shaped so as to allow torque transmission from the rotor 12 to the screening shaft 7.

The screening bucket 1 further comprises a clamp 18. The clamp 18 is positioned opposite to the shaft coupling portion 13 with respect to the rotor end 17 of the rotor 12, along a direction transverse to an axis parallel to the rotation axis 8 or radial to the rotation axis 8.

The clamp 18 is removably connected, optionally tightened, to the shaft coupling portion 13 so as to secure the rotor end 17 of the rotor 12 into the shaft recess 14, and specifically to contain the rotor end 17 between the shaft coupling portion 13 and the clamp 18.

Advantageously, a screening bucket 1 thus configured allows quick and easy assembly and disassembly of the screening assemblies 6 from and to the bucket body 2, and has reduced stress on the connection means, which allow the assembly and disassembly, and which further allow the correct centering between the screening shaft 7 and the rotor 12.

According to an embodiment, the clamp 18 is a rigid element, e.g., made of metal material.

According to an alternative embodiment, the clamp 18 is an elastic element, or non-rigid, or yielding. According to an embodiment, the clamp 18 is made of polymeric material.

Advantageously, a bucket 1 thus configured enables the use of a clamp 18 made of non-rigid, elastic material. Indeed, the clamp 18, thus configured, is not intended to be a structural element, but serves to ensure centering and constrain the geometric connection between screening shaft 7 and rotor 12, and accordingly it can also be made of non-rigid, elastic material, with consequent greater ease during assembly and disassembly.

According to an embodiment, the rotor end 17 forms two opposite planar rotor surfaces 20 parallel to each other and opposite with respect to the rotor axis 16. Furthermore, each planar rotor surface 20 extends on a respective plane parallel to the rotor axis 16.

According to this embodiment, the shaft coupling portion 13 forms two opposite planar shaft surfaces 21, mutually parallel and opposite with respect to the rotation axis 8. Furthermore, each planar shaft surface 21 extends on a respective plane parallel to the rotation axis 8.

The planar rotor surfaces 20 are positioned facing the respective planar shaft surfaces 21.

In this manner, in operating configuration, the mechanical and/or hydraulic power is transmitted between the rotor 12 and the screening shaft 7 by means of the abutment between at least two opposite planar rotor surfaces 20 and planar shaft surfaces 21.

The planar rotor surfaces 20 and the planar shaft surfaces 21 are substantially flat.

The planar shaft surfaces 21 partially define the shaft recess 14.

According to an embodiment, the shaft coupling portion 13 forms a containment surface 22 extending between the two opposite planar shaft surfaces 21.

The planar shaft surfaces 21, in combination with the containment surface 22, define the shaft recess 14.

The containment surface 22 closes the shaft recess 14, i.e., delimits its extension in a direction parallel to the planar shaft surfaces 21.

According to an embodiment, the rotor end 17 forms a pair of opposite transverse rotor surfaces 23 extending between the two opposite planar rotor surfaces 20. One of the two transverse rotor surfaces 23 is positioned facing the containment surface 22, while the other transverse rotor surface 23 faces in a direction opposite to the containment surface 22.

The planar rotor surfaces 20 extend between the two opposite transverse rotor surfaces 23.

According to an embodiment, the rotor end 17 forms only one rotor surface 20. According to a further embodiment, the rotor end 17 forms a plurality of rotor surfaces 20, wedge-shaped or prismatic or orthogonal to one another. According to this embodiment, the shaft coupling portion 13 forms at least one planar shaft surface 21 geometrically couplable with the at least one rotor surface 20 thus shaped.

According to an embodiment, the shaft coupling portion 13 forms a shaft coupling surface 25 substantially coplanar with the rotation axis 8 or with an axis parallel to the rotation axis 8.

Furthermore, the clamp 18 forms a clamp coupling surface 26 substantially coplanar with the rotation axis 8 to an axis parallel to the rotation axis 8.

The clamp coupling surface 26 faces the shaft coupling surface 25 and is parallel to the shaft coupling surface 25.

In a connected configuration, the clamp coupling surface 26 is clamped, optionally abutting, against the shaft coupling surface 25. According to an alternative embodiment, the clamp 18 is connected to the shaft end 10, but the clamp coupling surface 26 does not abut against the shaft end 10.

According to an embodiment, the clamp 18 is configured so as to be geometrically inscribable within the radial or transverse dimension of the screening shaft 7 and/or of the rotor 12. According to an embodiment, the radial or transverse dimension of the assembly formed by the clamp 18 and by a connection key corresponds to the radial or transverse dimension of the screening shaft 7 and/or of the rotor 12.

According to an embodiment, the rotor end 17, in a section orthogonal to the rotor axis 16, has a substantially slot-like shape.

According to this embodiment, the transverse rotor surfaces 23 have a substantially curved shape.

According to an embodiment, each planar shaft surface 21 has an extension, in a direction orthogonal to the rotation axis 8 or orthogonal to an axis parallel to the rotation axis 8, comprised between 66% and 100%, or between 80% and 100% or between 90% and 100%, or substantially equal to 100%, or greater than 100% of the extension, in a direction orthogonal to the rotation axis 8 or orthogonal to an axis parallel to the rotation axis 8, of the facing planar rotor surface 20.

Advantageously, this configuration allows the screening shaft 7 to be self-supporting during assembly. Indeed, before tightening the clamp 18 at the coupling end of shaft 13, the screening shaft 7 is self-supported on the rotor 12 by means of the coupling between the shaft recess 14 and the rotor 12.

The screening shaft 7 is fitted onto the rotor 12 by means of geometric coupling along a radial direction to the rotor axis 16 or orthogonal to an axis parallel to the rotor axis 16.

With a further advantage, this configuration implements the transmission of mechanical and/or hydraulic power between the rotor 12 and the screening shaft 7 through the facing planar rotor surfaces 20 and shaft surfaces 21, thereby avoiding the transmission of mechanical and/or hydraulic power through the clamp 18 and thus through the connection means which tighten the clamp 18 to the shaft coupling portion 13.

According to an embodiment, the clamp 18 is not superimposed on the planar rotor surfaces 20 in a direction transverse to the rotation axis 8 or in a direction orthogonal to an axis parallel to the rotation axis 8.

Advantageously, this configuration avoids a transmission of mechanical and/or hydraulic power through the clamp 18.

According to an embodiment, the clamp 18 forms a positioning surface 24 positioned facing the transverse rotor surface 23.

The positioning surface 24, in combination with the containment surface 22, encloses the rotor end 17 between the shaft coupling portion 13 and the rotor 12.

According to an embodiment, the shaft coupling portion 13 is connected to the clamp 18 by means of a plurality of reversible connection members.

According to an embodiment, the shaft coupling portion 13 is clamped to the clamp 18 by means of a plurality of threaded elements 19, e.g., threaded screws.

Each reversible connection member, preferably each threaded element 19, extends between the shaft coupling portion 13 and the clamp 18, externally to the shaft recess 14. Therefore, the reversible connection members, optionally the threaded elements 19, are positioned externally to the rotor end 17, i.e., do not pass through the rotor end 17.

According to this embodiment, the shaft coupling portion 13 and the clamp 18 respectively form at least one threaded hole and an opposite through hole, for inserting and screwing a respective threaded element 19 therein.

Preferably, the through holes are formed in the shaft coupling portion 13 while the threaded holes are formed in the clamp 18.

According to an embodiment, each threaded element 19 extends coplanar with a plane transverse to the rotation axis 8.

According to an embodiment, each threaded element 19 further extends orthogonal to a radial plane to the rotation axis 8.

According to an embodiment, each threaded element 19 extends along a direction parallel to planar rotor surfaces 20 or the planar shaft surfaces 21.

Advantageously, this configuration does not subject the threaded elements 19 to shear stresses and prevents the mechanical and/or hydraulic power transferred by the rotor 12 to the screening shaft 7 from passing through the threaded elements 19. Indeed, according to this configuration, the mechanical and/or hydraulic power transferred between the rotor and the screening shaft 7 is exchanged only at the respective planar rotor walls 20 and planar shaft walls 21, and is not transferred through the threaded elements 19.

According to an embodiment, the reversible connection members comprise, by way of explanation, a pin for an interference connection or further reversible connection means.

According to an embodiment, the shaft coupling portion 13 has a prismatic shape.

According to an embodiment, the combination of the shaft coupling portion 13 and the clamp 18, in a section orthogonal to the rotation axis 8, occupies a substantially rectangular or square-shaped radial dimension or radial footprint.

“Radial dimension or radial footprint” refers to the radial dimension or radial footprint with respect to the rotation axis 8.

The shaft coupling portion 13, in a section orthogonal to the rotation axis 8, is substantially U-shaped.

According to an embodiment, the entire screening shaft 7, in a section orthogonal to the rotation axis 8, is a substantially rectangular or square-shaped.

According to an embodiment, the shaft coupling portion 13 and the clamp 18 are contained within the radial footprint of the entire screening shaft 7.

Advantageously, such configuration reduces the overall dimensions of the connecting system of the screening shaft 7 to the rotor 12.

According to an embodiment, the shaft coupling portion 13 is comprised within the radial dimension or radial footprint of the entire screening shaft 7.

The screening shaft 7 comprises a tools connection portion 15. The screening tools 9 are removably connectable to the screening shaft 7 at the tool connection portion 15.

According to an embodiment, the tool connection portion 15 has a substantially constant section in a direction orthogonal to the rotation axis 8.

According to an embodiment, the shaft coupling portion 13 is comprised within the radial dimension or radial footprint of the tool connection portion 15.

According to an embodiment of the present invention, the screening bucket 1 comprises at least one axial containment element 27, 28 positioned at the shaft end 10 and configured to achieve an axial abutment for the screening tools 9 mounted on the screening shaft 7.

Specifically, the screening shaft 7 comprises a containment plate 27, e.g., substantially rectangular or parallelepiped-shaped, connectable to or positionable abutting the shaft coupling portion 13, so as to protrude radially with respect to the screening shaft 7 to axially intercept the screening tools 9.

Furthermore, the clamp 18 comprises a containment extension 28, preferably formed in one piece with the clamp 18 itself, protruding in the radial direction and adapted to achieve an axial abutment for the screening tools 9 on the side opposite to the containment plate 27.

Advantageously, this configuration allows the axial position of the screening tools 9 on the screening shaft 7 to be stably constrained, preventing slippage or undesired axial displacements of the tools 9 mounted close to the shaft ends 10 during the screening operations.

With further advantage, the integration of axial containment functions directly on the shaft coupling portion 13 and on the clamp 18 makes it possible to maintain a high compactness of the system, while at the same time ensuring quick and secure mounting of the screening tools 9 without requiring additional axial fastening components separate from the coupling system between shaft 7 and rotor 12.

According to an embodiment of the present invention, the containment plate 27 and the containment extension 28 are configured to be clamped to each other by means of the threaded elements 19. In particular, one of the containment plate 27 and the containment extension 28 defines at least one through hole, while the other either containment plate 27 or containment extension 28 defines a corresponding threaded hole for screwing the threaded element 19. Preferably, the containment plate 27 defines a plurality of through holes and the containment extension 28 defines a corresponding plurality of threaded holes.

Obviously, those skilled in the art will be able to make changes or adaptations to the present invention, without however departing from the scope of the following claims.

### LIST OF REFERENCES

1. Screening bucket
2. Bucket body
3. Loading compartment
4. Unloading opening
5. Side wall
6. Screening assembly
7. Screening shaft
8. Rotation axis
9. Screening tool
10. Shaft end
11. Transmission system
12. Rotor
13. Shaft coupling portion
14. Shaft recess
15. Tool connection portion
16. Rotor axis
17. Rotor end
18. Clamp
19. Threaded element
20. Planar rotor surface
21. Planar shaft surface
22. Containment surface
23. Transverse rotor surface
24. Positioning surface
25. Shaft coupling surface
26. Clamp coupling surface
27. Containment plate
28. Containment extension

What is claimed is

1. A screening bucket, comprising a bucket body defining a
loading compartment and an unloading opening, wherein the bucket body comprises two opposite side walls at least partially defining the unloading opening,
wherein the screening bucket comprises at least one screening assembly which comprises:
a screening shaft, extending between two opposite shaft ends, and rotatable about a rotation axis; and
a plurality of screening tools connected to the screening shaft,
wherein the screening bucket further comprises a transmission system positioned at at least one of the two opposite side walls and configured to transfer mechanical and/or hydraulic power to the at least one screening assembly,
wherein the transmission system comprises a rotor positioned at a side wall of the two opposite side walls and extending to protrude into the loading compartment and facing one of the two opposite shaft ends,
wherein one of either the screening shaft or the rotor forms a recess open at least in a direction transverse to an axis parallel to the rotation axis or radial to the rotation axis,
wherein the recess is blind in the direction transverse to the axis parallel to the rotation axis or radial to the rotation axis,
wherein the other of either the screening shaft or the rotor comprises an end removably inserted into the recess, so as to obtain a geometric coupling between the screening shaft and the rotor,
wherein the end and the recess are shaped so as to allow a torque transmission from the rotor to the screening shaft, and
wherein the screening bucket further comprises a clamp, wherein the clamp is removably connected to the screening shaft or the rotor so as to constrain the end in the recess.

2. The screening bucket of claim 1, wherein the clamp is a rigid element, made of metal material, or wherein the clamp is an elastic or non-rigid or yielding element, made of polymer material.

3. The screening bucket of claim 1, wherein the clamp is configured to be geometrically inscribable within a radial or transverse dimension of the screening shaft and/or the rotor.

4. A screening bucket, comprising a bucket body defining a loading compartment and an unloading opening, wherein the bucket body comprises two opposite side walls at least partially defining the unloading opening,
wherein the screening bucket comprises at least one screening assembly which comprises:
a screening shaft, extending between two opposite shaft ends, and rotatable about a rotation axis; and
a plurality of screening tools connected to the screening shaft,
wherein the screening bucket further comprises a transmission system positioned at at least one of the two opposite side walls and configured to transfer mechanical and/or hydraulic power to the at least one screening assembly,
wherein the transmission system comprises a rotor positioned at a side wall of the two opposite side walls and extending to protrude into the loading compartment and facing one of the two opposite shaft ends,
wherein the screening shaft forms, at the shaft end facing the rotor, a shaft coupling portion forming a shaft recess open at least in a direction transverse to an axis parallel to the rotation axis or radial to the rotation axis,
wherein the shaft recess is blind in the direction transverse to the axis parallel to the rotation axis or radial to the rotation axis,
wherein the rotor comprises a rotor end, removably inserted into the shaft recess, so as to obtain a geometric coupling with the shaft coupling portion,
wherein the rotor end and the shaft recess are shaped so as to allow a torque transmission from the rotor to the screening shaft,
wherein the screening bucket further comprises a clamp, positioned opposite to the shaft coupling portion with respect to the rotor end of the rotor along a direction transverse or radial to the rotation axis, and
wherein the clamp is removably connected to the shaft coupling portion so as to constrain the rotor end of the rotor in the shaft recess.

5. The screening bucket of claim 4, wherein the rotor defines a rotor axis, wherein the rotor end forms two opposite planar rotor surfaces parallel to each other and opposite to the rotor axis, wherein each planar rotor surface of the two opposite planar rotor surfaces extends on a respective plane parallel to the rotor axis,
wherein the shaft coupling portion forms two opposite planar shaft surfaces parallel to each other and opposite to the rotation axis, wherein each planar shaft surface of the two opposite planar shaft surfaces extends on a respective plane parallel to the rotation axis, and
wherein the planar rotor surfaces are positioned facing the respective planar shaft surfaces.

6. The screening bucket of claim 5, wherein each planar shaft surface has an extension, in a direction orthogonal to the rotation axis or orthogonal to the axis parallel to the rotation axis, comprised between 66% and 100%, or between 80% and 100% or between 90% and 100%, or substantially equal to 100%, or greater than 100% of an extension, in the direction orthogonal to the rotation axis or orthogonal to the axis parallel to the rotation axis, of the facing planar rotor surface.

7. The screening bucket of claim 5, wherein the clamp is not superimposed on the planar rotor surfaces in a direction transverse to the rotation axis or in a direction orthogonal to the axis parallel to the rotation axis.

8. The screening bucket of claim 5, wherein the shaft coupling portion is clamped to the clamp by a plurality of threaded elements, optionally the threaded elements being threaded screws, and wherein each threaded element of the plurality of threaded elements, extends between the shaft coupling portion and the clamp, externally to the shaft recess.

9. The screening bucket of claim 8, wherein the shaft coupling portion and the clamp form at least one threaded hole and an opposite through hole, respectively, for inserting and screwing a respective threaded element therein.

10. The screening bucket of claim 8, wherein each threaded element of the plurality of threaded elements extends coplanar with a plane transverse to the rotation axis and extends orthogonal to a plane radial to the rotation axis,
or wherein each threaded element of the plurality of threaded elements extends along a direction parallel to the planar rotor surface or planar shaft surface.

11. The screening bucket of claim 8, further comprising at least one axial containment element positioned at the shaft end and configured to achieve an axial abutment for the screening tools mounted on the screening shaft,
wherein the screening shaft comprises a containment plate connected to the shaft coupling portion and projecting radially with respect to the screening shaft, wherein the clamp comprises a containment extension projecting in a radial direction and adapted to achieve an axial abutment for the screening tools on a side opposite to the containment plate, and
wherein the containment plate and the containment extension are clampable to each other by the threaded elements.

12. The screening bucket of claim 4, wherein the rotor end forms only one rotor surface,
or wherein the rotor end forms a plurality of rotor surfaces that are wedge-shaped or prismatic or orthogonal to one another,
and wherein the shaft coupling portion forms at least one respective planar shaft surface geometrically couplable to the rotor surface thus shaped.

13. The screening bucket of claim 4, wherein the shaft coupling portion forms a shaft coupling surface substantially coplanar with the rotation axis or to the axis parallel to the rotation axis,
wherein the clamp forms a clamp coupling surface substantially coplanar with the rotation axis or to the axis parallel to the rotation axis,
wherein the clamp coupling surface faces the shaft coupling surface and is parallel to the shaft coupling surface, and
wherein, in a connected configuration, the clamp coupling surface is clamped, optionally abutting, against the shaft coupling surface.

14. The screening bucket of claim 4, wherein the rotor defines a rotor axis, and wherein the rotor end, in a section orthogonal to the rotor axis, is substantially slot-shaped.

15. The screening bucket of claim 4, wherein a combination of the shaft coupling portion and the clamp, in a section orthogonal to the rotation axis, occupies a radial footprint which is substantially rectangular or square in shape.

16. The screening bucket of claim 4, wherein the shaft coupling portion and the clamp are included in a radial footprint of the entire screening shaft.

17. The screening bucket of claim 4, wherein the shaft coupling portion is comprised in a radial footprint of the entire screening shaft.

18. The screening bucket of claim 4, wherein the clamp is a rigid element, made of metal material, or wherein the clamp is an elastic or non-rigid or yielding element, made of polymer material.

19. The screening bucket of claim 4, wherein the clamp is configured to be geometrically inscribable within a radial or transverse dimension of the screening shaft and/or the rotor.

20. The screening bucket of claim 4, wherein the shaft coupling portion, in a section orthogonal to the rotation axis, is substantially U-shaped.

21. The screening bucket of claim 4, wherein the screening shaft comprises a tool connection portion, wherein the screening tools are removably connectable to the screening shaft at the tool connection portion, wherein the tool connection portion has a substantially constant section in a direction orthogonal to the rotation axis, and wherein the shaft coupling portion is comprised in a radial dimension or footprint of the tool connection portion.
